(19) United States
(12) Patent Application Publication
(10) Pub. No.: US 2017/0161953 A1
(43) Pub. Date: Jun. 8, 2017

(54) PROCESSING METHOD AND DEVICE FOR COLLECTING SENSOR DATA

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Xuelian HU, Tianjin (CN)

(21) Appl. No.: 15/246,408

(22) Filed: Aug. 24, 2016

Related U.S. Application Data
(63) Continuation of application No. PCT/CN2016/089334, filed on Jul. 8, 2016.

(30) Foreign Application Priority Data
Dec. 4, 2015 (CN) 201510885481.3

(51) Int. Cl. G06T 19/00; G06F 3/01

(52) U.S. Cl. CPC G06T 19/006; G06F 3/011

(57) ABSTRACT

An embodiment of the present disclosure discloses a processing method and processing device for collecting sensor data. The method comprises: generating a fitted curve on the basis of historical sensor data; determining a target time corresponding to the target sensor data when detecting the target sensor data; calculating the target time according to the fitted curve, and obtaining virtual sensor data corresponding to the target time; comparing the target sensor data with the virtual sensor data, and eliminating abnormal target sensor data according comparison results. The embodiment of the present disclosure deletes abnormal target sensor data through detecting the degree of match between the target sensor data and the fitted curve, thus solving the problems of independent offset of image and difficult focusing during focus operation caused by abnormal sensor data.

### CROSS-REFERENCE TO RELATED APPLICATIONS

The present disclosure is a continuation of International Application No. PCT/CN2016/089334 filed on Jul. 8, 2016, which is based upon and claims priority to Chinese Patent Application No. 201510885481.3, entitled “PROCESSING METHOD AND DEVICE FOR COLLECTING SENSOR DATA”, filed on Dec. 4, 2015, the entire contents of all of which are incorporated herein by reference.

### TECHNICAL FIELD

The present disclosure generally relates to the field of virtual reality technologies, in particular to a processing method for collecting sensor data and a processing device for collecting sensor data.

### BACKGROUND

Virtual Reality (VR) is a multi-dimensional feeling reality including visual, audio and tactile senses completely or partly generated by a computer. Auxiliary sensing devices such as a helmet displayer, data gloves, etc., supply people with a multi-dimensional human-machine interface for observing interaction with the VR, so people can enter the VR to directly observe the interior changes of things and interactions when an event occurs, and really feel on the scene.

Along with the rapid development of VR technologies, VR cinema systems on the basis of a mobile terminal are also developing fast. In the VR cinema system on the basis of a mobile terminal, sensor data are the sources of video frames. Wherein, sensor data refer to data collected by a sensor installed on a sensing device. During the process of realizing the present disclosure, the inverter found that the accuracy of sensor data directly affect subsequent links such as calculation of a field angle, rendering of scenes and videos according to the field angle, TimeWarp processing, etc. When sensor data drift or jitter, an image generated by a VR system on the basis of a mobile phone can drift itself, meaning that a user can see a self-drifting image, reducing the user experience; and the problem of difficult focusing during focus operation can be caused.

Obviously, existing VR cinema systems on the basis of mobile terminals have the problems of independent offset of image and difficult focusing during focus operation caused by abnormal sensor data.

### SUMMARY

A technical problem to be solved by an embodiment of the present disclosure is to provide a processing method for collecting sensor data so as to solve the problems of independent offset of image and difficult focusing during focus operation caused by abnormal sensor data.

Correspondingly, an embodiment of the present disclosure also provides a processing device for collecting sensor data to ensure realization and application of the method.

According to an embodiment of the present disclosure, there is provided a processing method for collecting sensor data, at an electronic device, including:

generating a fitted curve on the basis of historical sensor data;

determining a target time corresponding to the target sensor data when detecting the target sensor data;

calculating the target time according to the fitted curve, and obtaining virtual sensor data corresponding to the target time;

comparing the target sensor data with the virtual sensor data, and eliminating abnormal target sensor data according comparison results.

According to an embodiment of the present disclosure, there is provided an electronic device for collecting sensor data, including:

at least one processor; and a memory connmmunicably connected with the at least one processor for storing instructions executable by the at least one processor, wherein execution of the instructions by the at least one processor causes the at least one processor to:

generate a fitted curve on the basis of historical sensor data;

determine a target time corresponding to the target sensor data when detecting the target sensor data;

calculate the target time according to the fitted curve, and obtain virtual sensor data corresponding to the target time;

compare the target sensor data with the virtual sensor data, and eliminate abnormal target sensor data according comparison results.

According to an embodiment of the present disclosure, there is provided a computer program, comprising computer readable codes, wherein the computer readable codes run on a mobile terminal so that the mobile terminal executes the processing method for collecting sensor data above.

According to an embodiment of the present disclosure, there is provided a non-transitory computer readable medium storing executable instructions that, when executed by an electronic device, cause the electronic device to: generate a fitted curve on the basis of historical sensor data; determine a target time corresponding to the target sensor data when detecting the target sensor data; calculate the target time according to the fitted curve, and obtain virtual sensor data corresponding to the target time; compare the target sensor data with the virtual sensor data, and eliminate abnormal target sensor data according comparison results.

Compared with the prior art, the embodiment of the present disclosure includes the following advantages:

when detecting the target sensor data, the embodiment of the present disclosure obtains the virtual sensor data corresponding to the target time through determining the target time corresponding to the target sensor data and calculating the target time according to the fitted curve, compares the target sensor data with the virtual sensor data, and eliminates abnormal target sensor data according to the comparison result, namely deleting abnormal target sensor data through detecting the degree of match between the target sensor data and the fitted curve, thus solving the problems of independent offset of image and difficult focusing during focus operation caused by abnormal sensor data.

### BRIEF DESCRIPTION OF THE DRAWINGS

To clearly describe the technical solution in the embodiments of the present disclosure or in the prior art, the following are brief introductions of the attached drawings used to describe the technology in the embodiments or in the prior art. Obviously, the attached drawings described below involve some embodiments of the present disclosure. For a person skilled in the art, other drawings can be made according to those drawings without creative labor.

FIG. 1 is a step flowchart of a processing method for collecting sensor data according to an embodiment of the present disclosure.

FIG. 2 is a step flowchart of a processing method for collecting sensor data according to an optimal embodiment of the present disclosure.

FIG. 3A is a structural block diagram of a processing device for collecting sensor data according to an embodiment of the present disclosure.

FIG. 3B is a structural block diagram of a processing device for collecting sensor data according to an optimal embodiment of the present disclosure.

FIG. 4 schematically illustrates a block diagram of an electronic device for executing the method according to the present disclosure.

FIG. 5 schematically illustrates a memory cell for holding or carrying program codes for realizing the method according to the present disclosure.

### DETAILED DESCRIPTION

One or more embodiments are illustrated by way of example, and not by limitation, in the figures of the accompanying drawings, wherein elements having the same reference numeral designations represent like elements throughout. The drawings are not to scale, unless otherwise disclosed.

In a VR cinema system on the basis of a mobile terminal, the view angle of an image is changed through head tracing, so a user's visual system and motion sensing system can be linked and the user feels more vividness. Usually, the head of the user can be traced through a position tracker to determine the motion state of the user's head. Wherein, the position tracker refers to a device for space tracking and positioning, usually used in combination with other VR devices, for example, a data helmet, 3D glasses, data gloves, etc., so participants can move and rotate freely in space, instead of being limited at a space position, and is not limited by a fixed space position. Actually, in the VR cinema system on the basis of a mobile terminal, sensor data are the source of video frames. The accuracy of sensor data directly affect subsequent links such as calculation of a field angle, rendering of scenes and videos according to the field angle, TimeWarp processing, etc. Abnormal sensor data causes problems of independent offset of image and difficult focusing during focus operation.

Aiming at the above problems, a core concept of the embodiment of the present disclosure is to generate a fitted curve according to historical sensor data and delete abnormal target sensor data through detecting the degree of match between the target sensor data and the fitted curve, thus solving the problems of independent offset of image and difficult focusing during focus operation caused by abnormal sensor data.

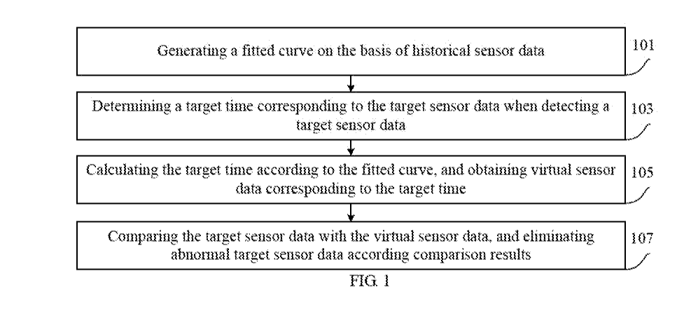

Refer to FIG. 1, which illustrates a step flowchart of a processing method for collecting sensor data according to an embodiment of the present disclosure. The method may specifically include the following steps.

Step 101: Generating a fitted curve on the basis of historical sensor data.

The VR system on the basis of the mobile terminal can monitor the motion state of a user's head through an auxiliary sensing device such as a data helmet, 3D glasses, data gloves, etc. Actually, the VR system on the basis of a mobile terminal can determine the current rotating state of the user through monitoring and collecting data collected by a sensor. Specifically, the VR system can define the data collected by the sensor as sensor data, calculate the collected sensor data, determine the field angle, render image frames in real time according to the determined field angle, and generate 3D images corresponding to various scenes. It needs to be noted that, the “mobile terminal” refers to a computer device capable of being used during movement, for example a smart mobile phone, a notebook computer, or a tablet computer. The embodiment of the present disclosure does not set a limit in this aspect. In this embodiment of the present disclosure, a mobile phone is taken as an example to carry out a detailed description.

When the VR system on the basis of a mobile phone collects sensor data, the VR system can take the collected sensor data as historical sensor data, form a sensor data sequence, simulate the sequence, and generate a fitted curve corresponding to the sensor data. The fitted curve can determine a relationship between the sensor data and time when the sensor data are collected, and the fitted curve can be marked as D=S (t). Wherein, D represents sensor data, and t represents time.

In an optimal embodiment of the present disclosure, step 101 can also include the following sub-steps:

sub-step 1010: collecting sensor data collected by a sensor;

sub-step 1012: serializing the collected sensor data as historical sensor data;

and sub-step 1013: performing analog calculation on the serialized historical sensor data and generating the fitted curve.

Step 103: Determining a target time corresponding to the target sensor data when detecting the target sensor data.

When detecting new sensor data, the VR system can define the detected new sensor data as target sensor data, acquire the current time, define the acquired current time as the time when the target sensor data are detected, and determine the target time corresponding to the target sensor data. For example, the VR system on the basis of the mobile phone detects new sensor data D0, namely target sensor data D0, acquires a current system time T1, and determines the current system time T1 as the target time corresponding to the target sensor data D0.

Step 105: Calculating the target time according to the fitted curve, and obtaining virtual sensor data corresponding to the target time.

Specifically, the VR system on the basis of the mobile phone can calculate the target time by using the fitted curve and obtain ideal sensor data corresponding to the target time, and the ideal sensor data can also be called virtual sensor data. With reference to the above example, the target time T1 is calculated through the fitted curve D=S (t), and ideal sensor data D1 corresponding to the target time T1 are obtained, wherein D1=S (t1), meaning that the virtual sensor data corresponding to the target time T1 are D1.

Step 107: Comparing the target sensor data with the virtual sensor data, and excluding abnormal target sensor data according to comparison results.

The VR system on the basis of the mobile phone can preset the offset threshold of sensor data. The offset threshold is used for determining if the detected sensor data are abnormal data, meaning that, when the offset of the target sensor data to the corresponding virtual sensor data is greater than the offset threshold, the target sensor data can be determined as abnormal data; and when the offset of the target sensor data to the corresponding virtual sensor data is not greater than the offset threshold, the target sensor data can be determined as normal data. Specifically, the difference value between the target sensor data and the virtual sensor data is calculated to determine if the difference value is greater than the preset offset threshold; when the difference value is greater than the preset offset, the target sensor data are discarded, and then abnormal target sensor data can be eliminated or deleted. In the above example, through calculation it can be determined that the difference value between the target sensor data D0 and the virtual sensor data D1 is |D0-D1|; the difference value |D0-D1| is compared with a preset offset threshold Y; when the difference value |D0-D1| is greater than the offset threshold Y, the target sensor data D0 are determined as abnormal sensor data, and the target sensor data D0 are deleted.

In an optimal embodiment of the present disclosure, step 107 can also include the following sub-steps:

sub-step 1070: calculating the difference value between the target sensor data and the virtual sensor data and determining offset data;

sub-step 1072: determining if the offset data is greater than a preset offset threshold;

sub-step 1074: if the offset data is greater than the offset threshold, defining the target sensor data as the abnormal target sensor data, and deleting the abnormal target sensor data.

In the embodiment of the present disclosure, the VR system on the basis of the mobile terminal can obtain virtual sensor data corresponding to the target time through determining the target time corresponding to the target sensor data and calculating the target time according to the fitted curve, compare the target sensor data with the virtual sensor data, and eliminate abnormal target sensor data according to the comparison result, namely deleting abnormal target sensor data through detecting the degree of match between the target sensor data and the fitted curve, thus solving the problems of independent offset of image and difficult focusing during focus operation caused by abnormal sensor data.

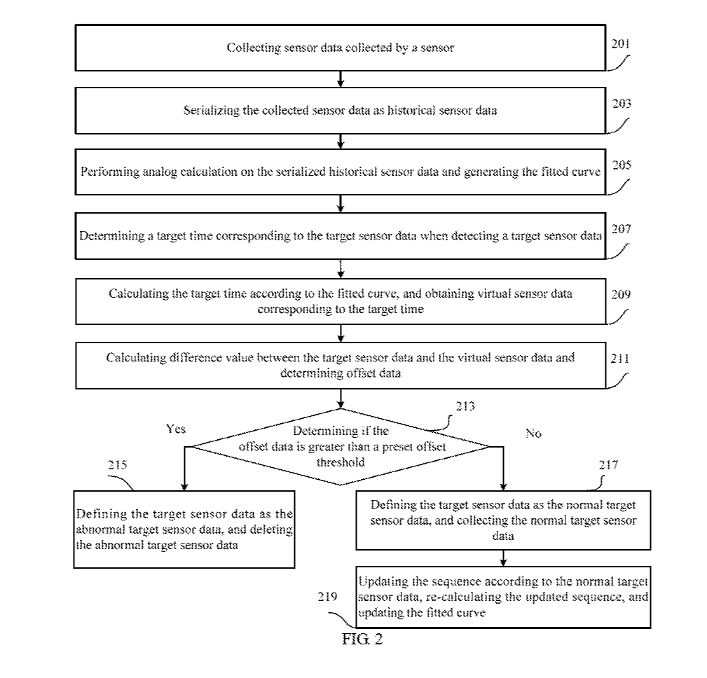

Refer to FIG. 2, which illustrates a step flowchart of a processing method for collecting sensor data according to an embodiment of the present disclosure. The method may specifically include the following steps.

Step 201: collecting sensor data collected by a sensor.

The VR system on the basis of the mobile phone monitors the user's state in real time and render the video or scenes according to the user's state, thus improving user experience. Usually, the sensor data D are uploaded very fast, which means that a sensing device can upload a plurality of sensor data D into the VR system in the delay time of a data frame. Wherein, the sensor data D can include but not limited to any one or several types of data such as gyroscope data (such as head direction) and accelerometer data (for example the value and direction of an acceleration on the mobile phone). The embodiment of the present disclosure does not set a limit in this aspect. In the following text, sensor data as a type of sensor data are taken as an example to describe the embodiment of the present disclosure, which should not be regarded as a limit on the embodiments of the present disclosure.

Aiming at the sensor data uploaded by the sensor, the VR system on the basis of the mobile phone can perform a statistic operation on the data and save the data, namely collecting the sensor data D collected by the sensor. Specifically, in order to improve the accuracy of the collected sensor data, the VR system can calculate the sensor data uploaded for every X batches when monitoring the sensor data uploaded by the sensor, obtain an average value of the every X batches of the uploaded sensor data, and save the average time. Wherein, X is an integer, for example 1, 2, 3, etc. For example, the VR system on the basis of the mobile phone aims at a certain type of sensor data D; through calculation of every three batches of the uploaded sensor data D, the average value of the same type of every three batches of the uploaded sensor data D can be obtained, and the average value is saved.

Step 203: Serializing the collected sensor data as historical sensor data.

The VR system can define the calculated average value as the historical sensor data Dtn, store average values in their corresponding sequence in turn, and form a sequence LD of the sensor data D. Wherein, tn represents the time when the average value Dtn of the sensor data is generated, equivalent to the time when the VR system collects the historical sensor data Dtn, wherein n is an integer, for example, 1, 2, 3, 4, etc. Specifically, the VR system on the basis of the mobile phone stores the average values Dtn (for example, Dt1, Dt2, Dt3, . . . ,) of the sensor data uploaded at different time tn (for example, t1, t2, t3, . . . ) into the corresponding state sequence LD, namely forming a sequence LD of the sensor data D. In order to ensure the efficiency of image rendering and calculate and obtain the accuracy of the field angel of the target scene, the sequence LD can be optimally set as a sequence in which 30 pieces of historical sensor data are stored, meaning that the last collected 30 historical sensor data Dtn can be stored in the sequence LD of the sensor data.

Step 205: Performing analog calculation on the serialized historical sensor data and generating the fitted curve.

The VR system on the basis of the mobile phone can perform an analog calculation on the historical sensor data Dtn in the target state sequence by calling a preset analog algorithm, and generate the fitted curve D=S(t) of the sequence LD. Wherein, D represents sensor data, and t represents time when the sensor data D are generated, equivalent to the time corresponding to the sensor data.

Step 207: Determining a target time corresponding to the target sensor data when detecting the target sensor data.

Specifically, the VR system on the basis of the mobile phone can define the last sensor data as the target sensor data D0 when detecting the last sensor data collected by the sensor, and determine the target time T1 corresponding to the target sensor data D0.

Step 209: Calculating the target time according to the fitted curve, and obtaining virtual sensor data corresponding to the target time.

In the embodiment of the present disclosure, the VR system on the basis of the mobile phone can define the target time T1 as tn, calculate the target time T1 by using the fitted curve D=S (t), and obtain ideal sensor data D1 corresponding to the target time T1.

Step 211: Calculating difference value between the target sensor data and the virtual sensor data and determining the offset data.

Specifically, the VR system on the basis of the mobile phone calculates the target sensor data D0 and the virtual sensor data D1, obtains the difference value |D0-D1| between the target sensor data D0 and the virtual sensor data D1, and defines the difference value |D0-D1| as the offset data corresponding to the target sensor data D0.

Step 213: Determining if the offset data is greater than a preset offset threshold.

The VR system on the basis of the mobile phone can determine if the offset data corresponding to the target sensor data D0 is greater than a preset offset threshold Y, executes step 215 if the offset data is greater than the offset threshold, and executes step 217 if the offset data is not greater than the offset threshold. Wherein, the offset threshold can be set according to the performance of the sensor and the accuracy required by the VR system. The present disclosure does not set a limit in this aspect.

Step 215: Defining the target sensor data as the abnormal target sensor data, and deleting the abnormal target sensor data.

Specifically, if the offset data corresponding to the target sensor data D0 is greater than a preset offset threshold Y, the target sensor data D0 are determined as abnormal data, which means that the target sensor data D0 are abnormal target sensor data, and the abnormal data are discarded, meaning that the target sensor data D0 are deleted, thus avoiding uploading the abnormal sensor data to the sequence LD of the sensor data D, improving the fitted curve D=S (t), ensuring the accuracy of the field angle, and the display effect of images.

Step 217: Defining the target sensor data as the normal target sensor data, and collecting the normal target sensor data.

If the offset data corresponding to the target sensor data D0 is not greater than a preset offset threshold Y, the target sensor data D0 are determined as normal data, which means that the target sensor data D0 are normal target sensor data, and the target sensor data D0 are uploaded, meaning that the target sensor data D0 are collected and saved.

Step 219: Updating the sequence according to the normal target sensor data, re-calculating the updated sequence, and updating the fitted curve.

Specifically, the VR system on the basis of the mobile phone can store the normal target sensor data D0 into the sequence LD when collecting the normal target sensor data D0, namely updating the sequence LD corresponding to the sensor data D; or the VR system on the basis of the mobile phone can perform a statistic operation on every several (for example 3) batches of the uploaded normal target sensor data D0, determine the average value of the several batches of normal target sensor data D0, and store the average value in the sequence LD to update the sequence LD of the sensor data D. After updating the sequence LD, the VR system on the basis of the mobile phone can re-calculate the updated sequence LD, and update the fitted curve D=S (t) corresponding to the sensor data D to further ensure the accuracy of the fitted curve D=S (t), thus improving the accuracy of the field angle.

In the embodiment of the present disclosure, the VR system on the basis of the mobile terminal can delete abnormal target sensor data through detecting the degree of match between the target sensor data and the fitted curve, thus solving the problems of independent offset of image and difficult focusing during focus operation caused by abnormal sensor data; and, the VR system on the basis of the mobile terminal can update the fitted curve in accordance with the normal target sensor data, ensuring the accuracy of the fitted curve, improving the accuracy of the field angle, and further ensuring the display effect of images.

It needs to be noted that, for simple description, the method embodiments are described as a series of action combinations, but a person skilled in the art understands that the embodiments of the present disclosure are not limited by the sequence of the described actions because according to the embodiments of the present disclosure, some steps can be implemented in other sequences or at the same time. Moreover, a person skilled in the art also should understand that the embodiments described in the present disclosure all belong to optimal embodiments, and some actions involved are not always needed by the embodiments of the present disclosure.

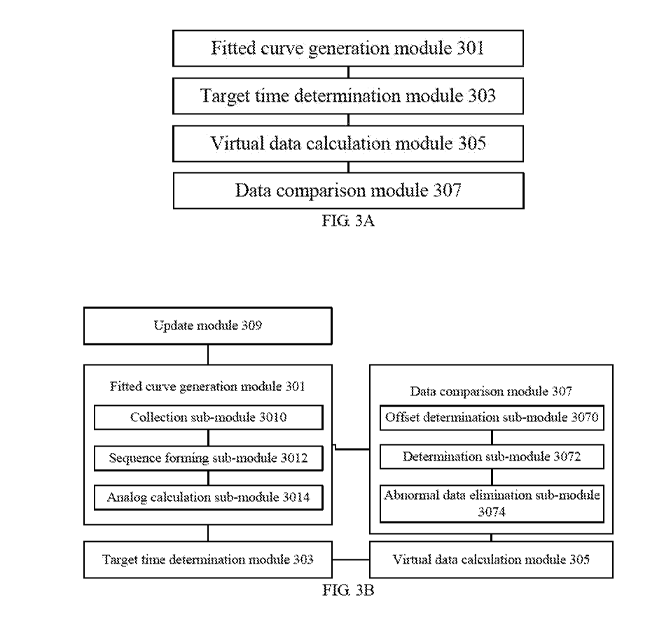

Refer to FIG. 3A, which illustrates a structural block diagram of a processing device for collecting sensor data according to an embodiment of the present disclosure. The device may specifically include the following modules:

a fitted curve generation module 301, used for generating a fitted curve on the basis of historical sensor data;

a target time determination module 303, used for determining a target time corresponding to the target sensor data when detecting the target sensor data;

a virtual data calculation module 305, used for calculating the target time according to the fitted curve, and obtaining virtual sensor data corresponding to the target time;

and a data comparison module 307, used for comparing the target sensor data with the virtual sensor data and eliminating abnormal target sensor data according comparison results.

Wherein, the sensor data can include but not limited to any one or several types of data such as gyroscope data (such as head direction) and accelerometer data (for example the value and direction of an acceleration on the mobile phone). The embodiment of the present disclosure does not set a limit in this aspect.

On the basis of FIG. 3A, optionally, the fitted curve generation module 301 can include a collection sub-module 3010, a sequence forming sub-module 3012 and an analog calculation sub-module 3014, with reference to FIG. 3B.

Wherein, the collection sub-module 3010 is used for collecting sensor data collected by a sensor; the sequence forming sub-module 3012 is used for serializing the collected sensor data as historical sensor data; and the analog calculation sub-module 3014 is used for performing analog calculation on the serialized historical sensor data and generating the fitted curve.

In an optimal embodiment of the present disclosure, the data comparison module 307 can include the following sub-modules:

an offset determination sub-module 3070, used for calculating the difference value between the target sensor data and the virtual sensor data and determining the offset data;

an determination sub-module 3072, used for determining if the offset data is greater than a preset offset threshold;

an abnormal data elimination sub-module 3074, used for, if the offset data is greater than the offset threshold, defining the target sensor data as the abnormal target sensor data, and deleting the abnormal target sensor data.

In an optimal embodiment of the present disclosure, the collection sub-module 3010 is also used for, if the offset data is not greater than the offset threshold, defining the target sensor data as the normal target sensor data, collecting the abnormal target sensor data, and triggering an updating module. The processing device for collecting sensor data also includes an updating module 309, wherein the updating module 309 is used for updating the sequence according to the normal target sensor data, triggering the analog calculation sub-module 3014 to re-calculate the updated sequence, and updating the fitted curve.

The device embodiment is basically the same as the method embodiments and therefore is simply described. Related contents can be seen in the related description of the method embodiments.

All embodiments of the present disclosures are described in a progressive manner. Every embodiment focuses on different factors. Identical and similar parts of the embodiments can be referenced to one another.

A person skilled in the art should understand that the embodiments of the present disclosure can be provided as methods, devices or computer program products. Therefore, the embodiments of the present disclosure can be complete hardware embodiments, complete software embodiments or embodiments in combination of software and hardware. Besides, the embodiments of the present disclosure can be one or more computer program products implemented in computer accessible storage media (including but not limited to magnetic disc memories, CD-ROMs, optical memories, etc.) which contain program codes for computers.

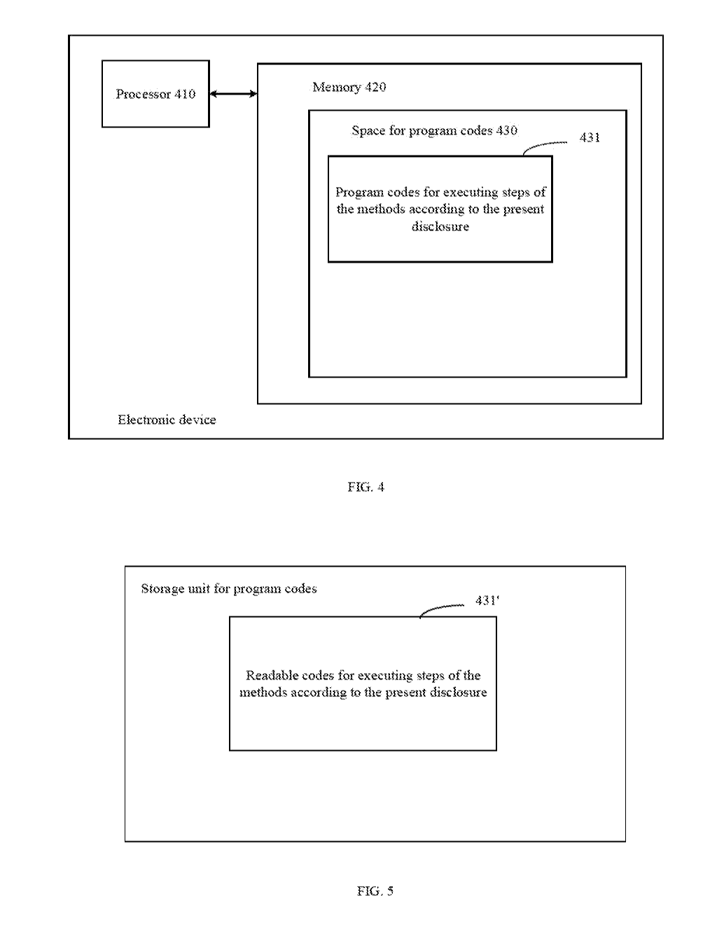

For example, FIG. 4 illustrates a block diagram of an electronic device for executing the method according the disclosure. The electronic device may be the mobile terminal above. Traditionally, the electronic device includes a processor 410 and a computer program product or a computer readable medium in form of a memory 420. The memory 420 could be electronic memories such as flash memory, EEPROM (Electrically Erasable Programmable Read-Only Memory), EPROM, hard disk or ROM. The memory 420 has a memory space 430 for executing program codes 431 of any steps in the above methods. For example, the memory space 430 for program codes may include respective program codes 431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 5. The memory cells may be provided with memory sections, memory spaces, etc., similar to the memory 420 of the electronic device as shown in FIG. 4. The program codes may be compressed for example in an appropriate form. Usually, the memory cell includes computer readable codes 431′ which can be read for example by processors 410. When these codes are operated on the electronic device, the electronic device may execute respective steps in the method as described above.

The embodiments of the present disclosure are described with reference to the flowcharts and/or block diagrams of the methods and terminal devices (systems) and computer program products of the embodiments of the present disclosure. It should be understood that the computer program commands realize every process and/or block in the flowcharts and/or block diagrams, and the combination of processes and/or blocks in the flowcharts and/or block diagrams. The computer program command can be supplied to the processor of a universal computer, a special computer, an embedded processing machine or other programmable data processing terminal devices to generate a machine, so the commands executed by the processor of the computer or other programmable data processing terminal devices generate a device for realizing specific functions in one or more processes in the flowcharts and/or one or more blocks in the block diagrams.

The computer program commands can also be stored in computer readable memories which guide the computer or other programmable data processing terminal devices to work in a specific mode, so the commands stored in the computer readable memories generate products including command devices, and the command devices conduct specific functions in one or more steps in the flowcharts and/or one or more blocks in the block diagrams.

The computer program commands can also be loaded in the computer or other programmable data processing terminal devices such that the computer or other programmable processing terminal devices execute a series of operations to generate processing executed by the computer. Thus, the commands executed in the computer or other programmable terminal devices supply processes of conducting specific functions in one or more processes in the flowcharts and/or one or more blocks in the block diagrams.

Although the optimal embodiments of the present disclosure are described, a person skilled in the art can make other changes and modifications on these embodiments when understanding the basic creative concept. Therefore, the protection scope of the claims is interpreted to include the optimal embodiments and all changes and modifications which fall within the embodiments of the present disclosure.

Finally, it is needed to be noted that, in the text, the relationship terms such as the “first” and the “second” are used for merely distinguishing an entity or operation from another entity or operation, and it is not always required or hinted that the entities or operation have such practical relationships or are in such sequences. Besides, the terms “comprise”, “include” or any other synonyms are intended to cover non-exclusive inclusion, so the processes, methods, articles or terminal devices of a series of elements include not only those elements, but also other elements, which are not clearly listed, or also include all inherent factors of those processes, methods, articles or terminals device. In the case of no more limits, the elements defined by the sentence “comprising/including a/an . . . ” should not exclude that the processes, methods, articles or terminal devices including the elements also include other identical elements.

The above are detailed descriptions of the processing method for collecting sensor data and the processing device for collecting sensor data. Specific examples are used in the text to describe the principle and implementation mode of the present disclosure. The description of the above embodiments is only used for the purpose of clarifying the method and essential concepts of the present disclosure. Meanwhile, for a person skilled in the art, changes may be made to the specific implementation modes and application scope according to the concept of the present disclosure. In conclusion, the contents of the description cannot be regarded as limits in the present disclosure.

What is claimed is:

1. A processing method for collecting sensor data, at an electronic device, comprising:
generating a fitted curve on the basis of historical sensor data;
determining a target time corresponding to the target sensor data when detecting the target sensor data;
calculating the target time according to the fitted curve, and obtaining virtual sensor data corresponding to the target time;
comparing the target sensor data with the virtual sensor data, and eliminating abnormal target sensor data according comparison results.

2. The method according to claim 1, wherein, generating the fitted curve on the basis of the historical sensor data comprises:
collecting sensor data collected by a sensor;
serializing the collected sensor data as historical sensor data;
and performing analogue calculation on the serialized historical sensor data and generating the fitted curve.

3. The method according to claim 2, wherein, comparing the target sensor data with the virtual sensor data, and eliminating abnormal target sensor data according to comparison results comprises:
calculating a difference value between the target sensor data and the virtual sensor data and determining offset data;
determining if the offset data is greater than a preset offset threshold;
if the offset data is greater than the offset threshold, defining the target sensor data as abnormal target sensor data, and deleting the abnormal target sensor data.

4. The method according to claim 3, further comprising:
if the offset data is not greater than the offset threshold, defining the target sensor data as the normal target sensor data, and collecting the abnormal target sensor data;
updating the sequence according to the normal target sensor data, re-calculating the updated sequence, and updating the fitted curve.

5. The method according to claim 1, wherein the sensor data at least include any one of the following: gyroscope data and accelerometer data.

6. An electronic device for collecting sensor data, comprising:
at least one processor; and
a memory communicably connected with the at least one processor for storing instructions executable by the at least one processor, wherein execution of the instructions by the at least one processor causes the at least one processor to:
generate a fitted curve on the basis of historical sensor data;
determine a target time corresponding to the target sensor data when detecting the target sensor data;
calculate the target time according to the fitted curve, and obtain virtual sensor data corresponding to the target time;
compare the target sensor data with the virtual sensor data, and eliminate abnormal target sensor data according comparison results.

7. The electronic device according to claim 6, wherein, the step to generate a fitted curve on the basis of historical sensor data comprises:
collect sensor data collected by a sensor;
serialize the collected sensor data as historical sensor data;
perform analog calculation on the serialized historical sensor data and generate the fitted curve.

8. The electronic device according to claim 7, wherein, the step to compare the target sensor data with the virtual sensor data, and eliminate abnormal target sensor data according to comparison results comprises:
calculate difference value between the target sensor data and the virtual sensor data and determine offset data;
determine whether the offset data is greater than a preset offset threshold;
if the offset data is greater than the offset threshold, define the target sensor data as the abnormal target sensor data, and delete the abnormal target sensor data.

9. The electronic device according to claim 8, wherein, the step to collect sensor data collected by a sensor comprises, if the offset data is not greater than the offset threshold, define the target sensor data as the normal target sensor data, and collect the abnormal target sensor data;
execution of the instructions by the at least one processor causes the at least one processor to: update the sequence according to the normal target sensor data, re-calculate the updated sequence, and update the fitted curve.

10. The electronic device according to claim 6, wherein the sensor data at least include any one of the following: gyroscope data and accelerometer data.

11. A non-transitory computer readable medium storing executable instructions that, when executed by an electronic device, cause the electronic device to:
generate a fitted curve on the basis of historical sensor data;
determine a target time corresponding to the target sensor data when detecting the target sensor data;
calculate the target time according to the fitted curve, and obtain virtual sensor data corresponding to the target time;
compare the target sensor data with the virtual sensor data, and eliminate abnormal target sensor data according comparison results.

12. The non-transitory computer readable medium according to claim 11, wherein, the step to generate a fitted curve on the basis of historical sensor data comprises:
collect sensor data collected by a sensor;
serialize the collected sensor data as historical sensor data;
perform analog calculation on the serialized historical sensor data and generate the fitted curve.

13. The non-transitory computer readable medium according to claim 12, wherein, the step to compare the target sensor data with the virtual sensor data, and eliminate abnormal target sensor data according to comparison results comprises:
calculate difference value between the target sensor data and the virtual sensor data and determining offset data;
determine whether the offset data is greater than a preset offset threshold;
if the offset data is greater than the offset threshold, define the target sensor data as the abnormal target sensor data, and delete the abnormal target sensor data.

14. The non-transitory computer readable medium according to claim 13, wherein, the step to collect sensor data collected by a sensor comprises: if the offset data is not greater than the offset threshold, define the target sensor data as the normal target sensor data, collect the abnormal target sensor data;
the electronic device is further caused to: update the sequence according to the normal target sensor data, re-calculate the updated sequence, and update the fitted curve.

15. The non-transitory computer readable medium according to claim 11, wherein the sensor data at least comprise any one of the following: gyroscope data and accelerometer data.
